(19) United States
(12) Patent Application Publication
(10) Pub. No.: US 2014/0122899 A1
(43) Pub. Date: May 1, 2014

(54) INFORMATION PROCESSING APPARATUS, INFORMATION PROCESSING METHOD, COMPUTER PROGRAM, AND INFORMATION PROCESSING SYSTEM

(71) Applicant: Sony Corporation, Minato-ku (JP)

(72) Inventors: Harunaga HIWATARI, Kanagawa (JP); Koichi Sakumoto, Tokyo (JP)

(73) Assignee: Sony Corporation, Minato-ku (JP)

(21) Appl. No.: 14/045,166

(22) Filed: Oct. 3, 2013

(30) Foreign Application Priority Data
Oct. 29, 2012 (JP) 2012-237622

(51) Int. Cl. G06F 21/72

(52) U.S. Cl. CPC G06F 21/72
USPC 713/189

(57) ABSTRACT

There is provided an information processing apparatus including circuitry configured to generate, in a state in which a function F which can calculate a same result for a plurality of different values x₁, . . . , xₙ (n is an integer of 2 or more), and a relation R between the values x₁, . . . , xₙ and values to be committed to another apparatus, are shared with the another apparatus in advance, the values x₁, . . . , xₙ which become a same result when applying the function F.

### CROSS REFERENCE TO RELATED APPLICATIONS

This application claims the benefit of Japanese Priority Patent Application JP 2012-237622 filed Oct. 29, 2012, the entire contents of which are incorporated herein by reference.

### BACKGROUND

The present disclosure relates to an information processing apparatus, a computer program, and an information processing system.

Bit commitment protocols are used in various locations in the field of encryption, and proposals of efficient implementation methods based on various problems are extremely beneficial. The purpose of bit commitment is to commit to a verifier the possession of bit data, without informing the values of this bit data possessed at present by the verifier himself or herself, and after this commitment, to be capable of verifying that this bit data has been committed at this time.

The security of a bit commitment protocol depends on the difficulty of the mathematical problems it is based on. Therefore, diversity can be formed by proposing a configuration method based on various problems. A configuration method of a bit commitment protocol based on a general one-way function has been known as an existing result of a configuration method for a bit commitment protocol (for example, refer to O. Goldreich and L. A. Levin, A Hard-Core Predicate for all One-Way Functions, STOC 1989; Iftach Haitner, Minh-Huyen Nguyen, Shien Jin Ong, Omer Reingold, Salil Vadhan: Statistically Hiding Commitments and Statistical Zero-Knowledge Arguments from Any One-Way Function, SIAM Journal on Computing 2009; and the like).

### SUMMARY

Existing bit commitment protocols, such as those disclosed in O. Goldreich and L. A. Levin, A Hard-Core Predicate for all One-Way Functions, STOC 1989; and Iftach Haitner, Minh-Huyen Nguyen, Shien Jin Ong, Omer Reingold, Salil Vadhan: Statistically Hiding Commitments and Statistical Zero-Knowledge Arguments from Any One-Way Function, SIAM Journal on Computing 2009, only satisfy a minimum security (computationally hiding), and a good efficiency is not to be expected. By considering such a situation, a highly efficient bit commitment protocol has been demanded while implementing a higher security.

Accordingly, the present disclosure proposes a new and improved information processing apparatus, information processing method, computer program, and information processing system capable of implementing a bit commitment protocol which satisfies a high security and achieves a high efficiency, by using a function in which a same result is obtained for different values.

According to an embodiment of the present disclosure, there is provided an information processing apparatus including circuitry configured to generate, in a state in which a function F which can calculate a same result for a plurality of different values x₁, . . . , xₙ (n is an integer of 2 or more), and a relation R between the values x₁, . . . , xₙ and values to be committed to another apparatus, are shared with the another apparatus in advance, the values x₁, . . . , xₙ which become a same result when applying the function F. The circuitry executes a commit stage which determines the values to be committed to the another apparatus by application of the relation R and a public stage which publically discloses the values committed in the commit stage, selects different values respectively corresponding to the values to be committed from the values x₁, . . . , xₙ in the commit stage and the public stage, and transmits the selected values to the another apparatus.

According to an embodiment of the present disclosure, there is provided an information processing apparatus including circuitry configured to apply, in a state in which a function F which can calculate a same result for a plurality of different values x₁, . . . , xₙ (n is an integer of 2 or more), and a relation R between the values x₁, . . . , xₙ and values to be committed by another apparatus, are shared with the another apparatus in advance, the function F to the values transmitted from the another apparatus. The circuitry executes a commit stage which receives first values corresponding to the values committed by the another apparatus by application of the relation R, and a public stage which receives second values for publically disclosing the values committed by the another apparatus. The circuitry judges, in the public stage, whether or not the first values and the second values are different, and whether or not there is a same result when applying the function F to the first values and the second values.

According to an embodiment of the present disclosure, there is provided an information processing system including a first information processing apparatus and a second information processing apparatus. A function F which can calculate a same result for a plurality of different values x₁, . . . , xₙ (n is an integer of 2 or more), and a relation R between the values x₁, . . . , xₙ and values to be committed to the second apparatus, are shared between the first information processing apparatus and the second information processing apparatus. The first information processing apparatus includes first circuitry configured to generate the values x₁, . . . , xₙ which become a same result when applying the function F. The first circuitry executes a commit stage which determines the values to be committed to the second information processing apparatus by application of the relation R and a public stage which publically discloses the values committed in the commit stage, selects different values respectively corresponding to the values to be committed from the values x₁, . . . , xₙ in the commit stage and the public stage, and transmits first values in the commit stage and second values in the public stage to the second information processing apparatus. The second information processing apparatus includes second circuitry configured to apply the function F to the values transmitted from the first information processing apparatus. The second circuitry executes a commit stage which receives the first values corresponding to the values committed by the first information processing apparatus by application of the relation R, and a public stage which receives the second values for publically disclosing the values committed by the first information processing apparatus. The second circuitry judges, in the public stage, whether or not the first values and the second values are different, and whether or not there is a same result when applying the function F to the first values and the second values.

According to an embodiment of the present disclosure, there is provided an information processing method including generating, in a state in which a function F which can calculate a same result for a plurality of different values x₁, . . . , xₙ (n is an integer of 2 or more), and a relation R between the values x₁, . . . , xₙ and values to be committed to another apparatus, are shared with the another apparatus in advance, the values x₁, . . . , xₙ which become a same result when applying the function F, determining the values to be committed to the another apparatus by application of the relation R, and publically disclosing the values committed by the commit step. Different values respectively corresponding to the values to be committed from the values x₁, . . . , xₙ by the commit step and the publically disclosing step are selected, and the selected values are transmitted to the another apparatus.

According to an embodiment of the present disclosure, there is provided an information processing method including receiving, in a state in which a function F which can calculate a same result for a plurality of different values x₁, . . . , xₙ (n is an integer of 2 or more), and a relation R between the values x₁, . . . , xₙ and values to be committed by another apparatus, are shared with the another apparatus in advance, first values corresponding to the values committed by the another apparatus by application of the relation R, receiving second values for publically disclosing the values committed by the another apparatus, and judging whether or not the first values and the second values are different, and whether or not there is a same result when applying the function F to the first values and the second values.

According to an embodiment of the present disclosure, there is provided a computer program for causing a computer to execute generating, in a state in which a function F which can calculate a same result for a plurality of different values x₁, . . . , xₙ (n is an integer of 2 or more), and a relation R between the values x₁, . . . , xₙ and values to be committed to another apparatus, are shared with the another apparatus in advance, the values x₁, . . . , xₙ which become a same result when applying the function F, determining the values to be committed to the another apparatus by application of the relation R, and publically disclosing the values committed by the commit step. Different values respectively corresponding to the values to be committed from the values x₁, . . . , xₙ by the commit step and the publically disclosing step are selected, and the selected values are transmitted to the another apparatus.

According to an embodiment of the present disclosure, there is provided a computer program for causing a computer to execute receiving, in a state in which a function F which can calculate a same result for a plurality of different values x₁, . . . , xₙ (n is an integer of 2 or more), and a relation R between the values x₁, . . . , xₙ and values to be committed by another apparatus, are shared with the another apparatus in advance, first values corresponding to the values committed by the another apparatus by application of the relation R, receiving second values for publically disclosing the values committed by the another apparatus, and judging whether or not the first values and the second values are different, and whether or not there is a same result when applying the function F to the first values and the second values.

According to one or more embodiments of the present disclosure such as described above, a new and improved information processing apparatus, information processing method, computer program, and information processing system can be provided capable of implementing a bit commitment protocol which satisfies a high security and achieves a high efficiency, by using a function in which a same result is obtained for different values.

### BRIEF DESCRIPTION OF THE DRAWINGS

FIG. 1 is an explanatory view illustrating a configuration of an algorithm according to a public key authentication scheme;

FIG. 2 is an explanatory view illustrating a configuration of an algorithm according to a digital signature scheme;

FIG. 3 is an explanatory view illustrating a configuration of an algorithm according to an n-pass public key authentication scheme;

FIG. 4 is a flow chart which shows the flow of a bit commitment protocol;

FIG. 5 is a flow chart which shows the flow of an existing bit commitment protocol;

FIG. 6 is an explanatory view illustrating a configuration example of an information processing system 1 according to an embodiment of the present disclosure;

FIG. 7 is a flow chart which shows an operation example of the information processing system 1 according to an embodiment of the present disclosure;

FIG. 8 is an explanatory view illustrating a prediction of a magnitude relation between x₁ and x₂ by a value of x₁;

FIG. 9 is an explanatory view visually illustrating a relation R2(x₁, x₂);

FIG. 10 is a flow chart which shows the flow of a string commitment protocol using the information processing system 1 according to an embodiment of the present disclosure;

FIG. 11 is a flow chart which shows an operation example of the information processing system 1 according to an embodiment of the present disclosure; and

FIG. 12 is an explanatory view illustrating a hardware configuration of an information processing apparatus.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The description will be given in the following order.

<1. Description of a public key authentication scheme and a secret key>

<2. Description of an existing bit commitment protocol>

<3. The embodiments of the present disclosure>

[System configuration example]

[System operation example]

[Modified example]

<4. Hardware configuration>

<5. Conclusion>

### 1. Description of a Public Key Authentication Scheme and a Secret Key

prior to describing suitable embodiments of the present disclosure, first an overview of a public key authentication scheme and a digital signature scheme will be described, and to continue, a secret key used by each of the later described embodiments of the present embodiment will be described.

A public key authentication scheme is an authentication scheme where a person (prover) convinces another person (verifier) that she is the prover herself by using a public key pk and a secret key sk. For example, a public key pk_{A} of a prover A is made known to the verifier. On the other hand, a secret key sk_{A} of the prover A is secretly managed by the prover. According to the public key authentication scheme, a person who knows the secret key sk_{A} corresponding to the public key pk_{A} is regarded as the prover A herself.

In the case the prover A attempts to prove to a verifier B that she is the prover herself, the prover A can perform an interactive protocol with the verifier B and prove that she knows the secret key sk_{A} corresponding to the public key pk_{A}. Then, in the case it is proved by the verifier B, by the interactive protocol, that the prover A knows the secret key sk_{A}, the legitimacy of the prover A (that she is the prover herself) is proved.

Additionally, to ensure security of the public key authentication scheme, two conditions set forth below are to be satisfied.

The first condition is to lower as much as possible the probability of falsification being established, at the time the interactive protocol is performed, by a falsifier not having the secret key sk. That this first condition is satisfied is called “soundness.” In other words, with a sound interactive protocol, falsification is not established by a falsifier not having the secret key sk with a non-negligible probability. The second condition is that, even if the interactive protocol is performed, information on the secret key sk_{A} of the prover A is not at all leaked to the verifier B. That this second condition is satisfied is called “zero knowledge.”

The security of the public key authentication scheme is ensured by using an interactive protocol having the soundness and zero knowledge as described above.

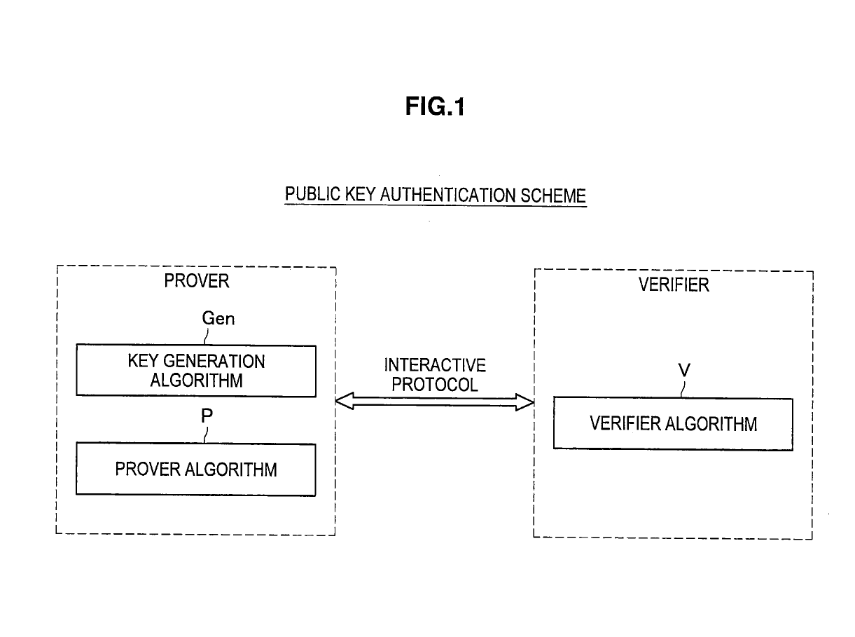

In a model of the public key authentication scheme, two entities, namely a prover and a verifier, are present, as shown in FIG. 1. The prover generates a pair of public key pk and secret key sk unique to the prover by using a key generation algorithm Gen. Then, the prover performs an interactive protocol with the verifier by using the pair of secret key sk and public key pk generated by using the key generation algorithm Gen. At this time, the prover performs the interactive protocol by using a prover algorithm P. As described above, in the interactive protocol, the prover proves to the verifier, by using the prover algorithm P, that she possesses the secret key sk.

On the other hand, the verifier performs the interactive protocol by using a verifier algorithm V, and verifies whether or not the prover possesses the secret key corresponding to the public key that the prover has published. That is, the verifier is an entity that verifies whether or not a prover possesses a secret key corresponding to a public key. As described, a model of the public key authentication scheme is configured from two entities, namely the prover and the verifier, and three algorithms, namely the key generation algorithm Gen, the prover algorithm P and the verifier algorithm V.

Additionally, expressions “prover” and “verifier” are used in the following description, but these expressions strictly mean entities. Therefore, the subject that performs the key generation algorithm Gen and the prover algorithm P is an information processing apparatus corresponding to the entity “prover”. Similarly, the subject that performs the verifier algorithm V is an information processing apparatus.

### (Key Generation Algorithm Gen)

The key generation algorithm Gen is used by a prover. The key generation algorithm Gen is an algorithm for generating a pair of public key pk and secret key sk unique to the prover. The public key pk generated by the key generation algorithm Gen is published. Furthermore, the published public key pk is used by the verifier. On the other hand, the secret key sk generated by the key generation algorithm Gen is secretly managed by the prover. The secret key sk that is secretly managed is used to prove to the verifier of possession of the secret key sk corresponding to the public key pk. Formally, the key generation algorithm Gen is represented as formula (1) below as an algorithm that takes security parameter 1^{λ} (λ, is an integer of 0 or more) as an input and outputs the secret key sk and the public key pk.

(sk,pk)←Gen(1^{λ}) (1)

### (Prover Algorithm P)

The prover algorithm P is used by a prover. The prover algorithm P is an algorithm for proving possession of the secret key sk corresponding to the public key pk. The prover algorithm P is defined as an algorithm that takes the public key pk and the secret key sk of a prover as inputs and performs the interactive protocol with a verifier.

### (Verifier Algorithm V)

The verifier algorithm V is used by a verifier. The verifier algorithm V is an algorithm for verifying, in the interactive protocol, whether or not a prover possesses the secret key sk corresponding to the public key pk. The verifier algorithm V is defined as an algorithm that takes the public key pk of a prover as an input, and that outputs 0 or 1 (1 bit) after performing the interactive protocol with the prover. Moreover, in the case of output 0, the prover is assumed to be illegitimate, and in the case of output 1, the prover is assumed to be legitimate. Formally, the verifier algorithm V is represented as formula (2) below.

0/1←V(pk) (2)

As described above, the public key authentication scheme has to satisfy two conditions, i.e. soundness and zero knowledge, to ensure security. However, in order to make a prover prove that she possesses the secret key sk, it is necessary that the prover perform a procedure dependent on the secret key sk, notify the verifier of the result and make the verifier perform verification based on the notified contents. Execution of the procedure dependent on the secret key sk is necessary to guarantee the soundness. On the other hand, it is necessary that information on the secret key sk is not at all leaked to the verifier even when the result of the procedure is notified to the verifier. Accordingly, it is necessary that the key generation algorithm Gen, the prover algorithm P, and the verifier algorithm V are designed so as to satisfy these terms.

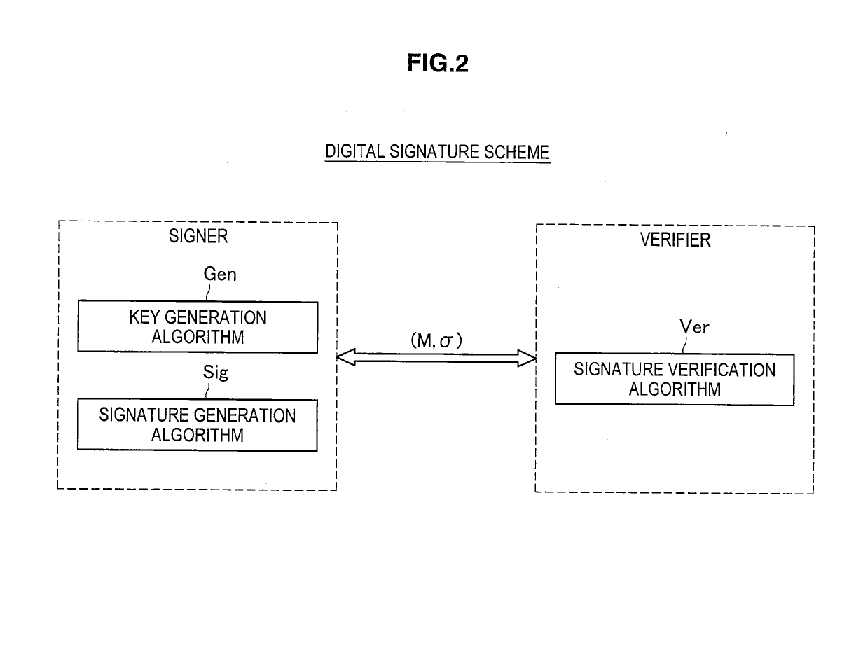

Next, an overview of the algorithm of a digital signature scheme will be provided with reference to FIG. 2. FIG. 2 is an explanatory view illustrating an overview the algorithm of a digital signature scheme.

In contrast to paper documents, it is difficult to put a stamp or affix a signature to digitized data. Thus, to prove the creator of digitized data, an electronic mechanism achieving an effect similar to putting a stamp or affixing a signature is necessary. The mechanism is the digital signature. The digital signature is a mechanism in which signature data known only to the creator of data is provided to a recipient by associating with the data and the signature data is verified by the recipient.

### (Model)

In a model of the digital signature scheme, as shown in FIG. 2, two entities called a signer and a verifier exist. Then, the model of the digital signature scheme includes three algorithms of the key generation algorithm Gen, a signature generation algorithm Sig, and a signature verification algorithm Ver.

The signer generates a pair of a signature key sk and a verification key pk unique to the signer by using the key generation algorithm Gen. The signer also generates a digital signature a to be attached to a document M by using the signature generation algorithm Sig. That is, the signer is an entity that attaches a digital signature to the document M. On the other hand, the verifier verifies the digital signature a attached to the document M by using the signature verification algorithm Ver. That is, the verifier is an entity that verifies the digital signature a to check whether the creator of the document M is the signer.

In the description that follows, the expressions of “signer” and “verifier” are used and these expressions mean entities in a strict sense. Therefore, the main body executing the key generation algorithm Gen and the signature generation algorithm Sig is an information processing apparatus corresponding to the entity of the “signer”. Similarly, the main body executing the signature verification algorithm Ver is an information processing apparatus. The hardware configuration of these information processing apparatuses is, for example, as shown in FIG. 38. That is, the key generation algorithm Gen, the signature generation algorithm Sig, and the signature verification algorithm Ver are executed by the CPU 902 or the like based on a program recorded in the ROM 904, the RAM 906, the storage unit 920, the removable recording medium 928 or the like.

### (Key Generation Algorithm Gen)

The key generation algorithm Gen is used by the signer. The key generation algorithm Gen is an algorithm that generates a pair of the signature key sk and the verification key pk unique to the signer. The verification key pk generated by the key generation algorithm Gen is made public. On the other hand, the signature key sk generated by the key generation algorithm Gen is managed in secret by the signer. Then, the signature key sk is used for the generation of the digital signature a to be attached to the document M. For example, the key generation algorithm Gen takes a security parameter 1^{λ} (λ is an integer equal to 0 or greater) as input and outputs the signature key sk and the verification key pk. In this case, the key generation algorithm Gen can be expressed formally like the following formula (3):

(sk,pk)←Gen(1^{λ}) (3)

### (Signature Generation Algorithm Sig)

The signature generation algorithm Sig is used by the signer. The signature generation algorithm Sig is an algorithm that generates the digital signature a to be attached to the document M. The signature generation algorithm Sig is an algorithm that takes the signature key sk and the document M as input and outputs the digital signature a. The signature generation algorithm Sig can formally be expressed like the following formula (4):

σ←Sig(sk,M) (4)

### (Signature Verification Algorithm Ver)

The signature verification algorithm Ver is used by the verifier. The signature verification algorithm Ver is an algorithm to verify whether the digital signature σ is a valid digital signature to the document M. The signature verification algorithm Ver is an algorithm that takes the verification key pk of the signer, the document M, and the digital signature a as input and outputs 0 or 1 (1 bit). The signature verification algorithm Ver can formally be expressed like the following formula (5): The verifier judges that the digital signature σ is invalid if the signature verification algorithm Ver outputs 0 (the verification key pk rejects the document M and the digital signature σ) and judges that the digital signature a is valid if the signature verification algorithm Ver outputs 1 (the verification key pk accepts the document M and the digital signature σ).

0/1←Ver(pk,M,σ) (5)

(n-Pass Public Key Authentication Scheme)

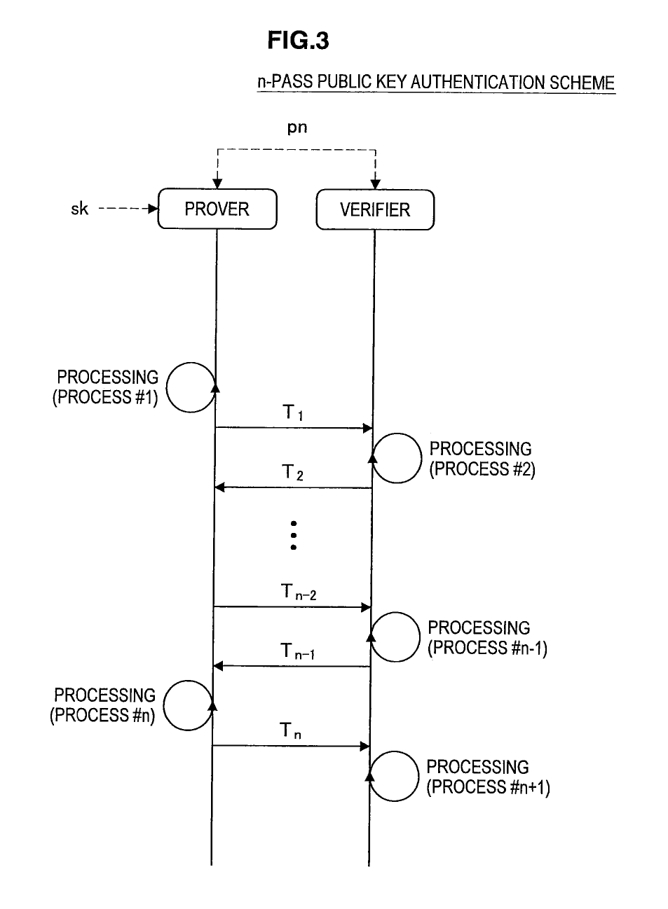

Next, an n-pass public key authentication scheme will be described with reference to FIG. 3. FIG. 3 is an explanatory view illustrating an n-pass public key authentication scheme.

The public key authentication scheme is, as described above, an authentication scheme that proves to the verifier that the prover holds the secret key sk corresponding to the public key pk during interactive protocol. Moreover, it is necessary for the interactive protocol to satisfy two conditions of soundness and zero knowledge. Thus, as shown in FIG. 3, the prover and the verifier exchange information n times while each performing respective processing.

In the n-pass public key authentication scheme, processing (process #1) is performed by the prover by using the prover algorithm P and information T₁ is transmitted to the verifier. Next, processing (process #2) is performed by the verifier by using the verifier algorithm V and information T₂ is transmitted to the prover. Further, processing is performed and information Tₖ is transmitted sequentially for k=3 to n before processing (process #n+1) is performed lastly. The scheme by which information is transmitted and received n times as described above is called the “n-pass” public key authentication scheme.

In the foregoing, the n-pass public key authentication scheme has been described.

As described above, there are public key authentication schemes and digital signature schemes, for example, disclosed in JP 2012-98690A, which take a basis for security from the difficulty in solving multi-order multivariate simultaneous equations, as satisfying the requirements when designing the key generation algorithm Gen, the prover algorithm P, and the verifier algorithm V. A function used by JP 2012-98690A is a function constituted by an n variable quadratic polynomial in m lines (m and n are each integers of 2 or more), and by using this function, a public key authentication scheme such as that of JP 2012-98690A can generate a plurality of secret keys from one public key. The function constituted by an n variable multi-order polynomial in m lines used by JP 2012-98690A is called an MQ (Multivariate Quadratic) function.

First, a key generation algorithm of the public key authentication scheme by JP 2012-98690A will be described. Here, the case will be considered where a set of quadratic polynomials (f₁(x), . . . , fₘ(x)) are used as one part of the public key pk. However, the quadratic polynomial fᵢ(x) is expressed such as in the following formula (6). Further, a vector (x₁, . . . , xₙ) is represented as x, and the set of quadratic polynomials (f₁(x), . . . , fₘ(x)) is represented as a multivariable polynomial F(x).

$${f}_{i} ( {x}_{1} , … , {x}_{n} ) = {\sum }_{j , k} {a}_{ijk} {x}_{j} {x}_{k} + {\sum }_{j} {b}_{ij} {x}_{j} \qquad ( 6 )$$

Further, the set of quadratic polynomials (f₁(x), . . . , fₘ(x)) can be expressed such as in the following formula (7). Further, A₁, . . . , Aₘ are n×n matrices. In addition, b₁, . . . , bₘ are each an n×1 vector.

$$F ( x ) = ( \begin{matrix}{f}_{1} ( x ) \\ ⋮ \\ {f}_{m} ( x )\end{matrix} ) = ( \begin{matrix}{x}^{T} {A}_{1} x + {b}_{1}^{T} x \\ ⋮ \\ {x}^{T} {A}_{m} x + {b}_{m}^{T} x\end{matrix} ) \qquad ( 7 )$$

When using this expression, the multivariable polynomial F can be expressed such as in the following formulas (8) and (9). The establishment of this expression can be easily ascertained from the following formula (10).

$$\begin{matrix}F ( x + y ) = F ( x ) + F ( y ) + G ( x , y ) & ( 8 ) \\ G ( x , y ) = ( \begin{matrix}{y}^{T} ( {A}_{1}^{T} + {A}_{1} ) x \\ ⋮ \\ {y}^{T} ( {A}_{m}^{T} + {A}_{m} ) x\end{matrix} ) & ( 9 ) \\ \begin{matrix}{f}_{i} ( x + y ) = {( x + y )}^{T} {A}_{i} ( x + y ) + {b}_{i}^{T} ( x + y ) \\ = {x}^{T} {A}_{i} x + {x}^{T} {A}_{i} y + {y}^{T} {A}_{i} x + {y}^{T} {A}_{i} y + {b}_{i}^{T} x + {b}_{i}^{T} y \\ = {f}_{i} ( x ) + {f}_{i} ( y ) + {x}^{T} {A}_{i} y + {y}^{T} {A}_{i} x \\ = {f}_{i} ( x ) + {f}_{i} ( y ) + {{x}^{T} ( {A}_{i}^{T} )}^{T} y + {y}^{T} {A}_{i} x \\ = {f}_{i} ( x ) + {f}_{i} ( y ) + {( {A}_{i}^{T} x )}^{T} y + {y}^{T} {A}_{i} x \\ = {f}_{i} ( x ) + {f}_{i} ( y ) + {y}^{T} ( {A}_{i}^{T} x ) + {y}^{T} {A}_{i} x \\ = {f}_{i} ( x ) + {f}_{i} ( y ) + {y}^{T} ( {A}_{i}^{T} + {A}_{i} ) x\end{matrix} & ( 10 )\end{matrix}$$

At the time when dividing into such a first portion, in which F(x+y) depends on x, a second portion, in which F(x+y) depends on y, and a third portion, in which F(x+y) depends on both x and y, a term G(x,y) corresponding to the third portion becomes bilinear for x and y. Hereinafter, there will be cases where the item G(x,y) is called a bilinear item. When using this property, it becomes possible to build an efficient algorithm.

For example, the multivariable polynomial F₁(x), which is used for a mask of a multivariable polynomial F(x+r), is represented as F₁(x)=G(x,t₀)+e₀ by using vectors (t₀ of Kⁿ) and (e₀ of K^{m}). In this case, the sum of the multivariable polynomials F(x+r₀) and F₁(x) is expressed such as in the following formula (11). Here, if t₁=r₀+t₀ and e₁=F(r₀)+e₀, the multivariable polynomial F₂(x)=F(x+r₀)+F₁(x) can be expressed by the vectors (t₁ of Kⁿ) and (e₁ of K^{m}). Therefore, if setting F₁(x)=G(x,t₀)+e₀, F₁ and F₂ can be expressed by using a vector on Kⁿ and a vector on K^{m}, and it becomes possible for an efficient algorithm to be expressed with a reduced data size necessary for communication.

$$\begin{matrix}F ( x + {r}_{0} ) + {F}_{1} ( x ) = F ( x ) + F ( {r}_{0} ) + G ( x , {r}_{0} ) + G ( x , {t}_{0} ) + {e}_{0} \\ = F ( x ) + G ( x , {r}_{0} + {t}_{0} ) + F ( {r}_{0} ) + {e}_{0}\end{matrix} \qquad ( 11 )$$

Note that information related to r₀ from F₂ (or F₁) is not leaked at all. For example, as long as e₀ and t₀ (or e₁ and t₁) are not known, the information of r₀ is not able to be known at all, even if provided with e₁ and t₁ (or e₀ and t₀). Therefore, a zero-knowledge property is secured.

Here, in the case of m=n, an MQ function can obtain x₁ and x₂ which becomes F(x₁)=F(x₂). The specific derivation method is as follows.

When n=m, at the time when (Δ of GF) (2ⁿ) is provided for the MQ function, an algorithm will exist which outputs x(s.t. F(x)=F(x+Δ). This is because the following function holds.

F(x)=F(x+Δ) [symbol] F(Δ)+G(x,Δ)=0

The above described function becomes a simultaneous linear equation which relates to x=(x₁, . . . , xₙ) and xᵢ=GF(2). Since the number of the variables xᵢ(i=1, 2, . . . , n) and the line number m of the formula matches, a solution x can be derived from the above described simultaneous linear equation.

Further, when n=cm (c is an integer of 2 or more), at the time when (Δ₁, . . . , Δ_{c} of GF) (2ⁿ) is provided for the MQ function, an algorithm will exist which outputs x(s.t. F(x)=F(x+Δ_{I})==F(x+Δ_{c}). This is because the following functions hold.

$$F ( x ) = F ( x + {Δ}_{1} ) ↔ F ( {Δ}_{1} ) + G ( x , {Δ}_{1} ) = 0$$

$$…$$

$$F ( x ) = F ( x + {Δ}_{c} ) ↔ F ( {Δ}_{c} ) + G ( x , {Δ}_{c} ) = 0$$

Each of the above described equations becomes a simultaneous linear equation which relates to x=(x₁, . . . , xₙ) and xᵢ=GF(2). When combining each of the above described equations, the line number of the equation becomes a simultaneous linear equation of cm for the variables xi(i=1, 2, . . . , n). Therefore, similar to the case of n=m, a solution x can be derived from the above described simultaneous linear equation.

In this way, by using an MQ function used by a public key authentication scheme which can generate a plurality of secret keys from one public key, it becomes possible to implement a bit commitment protocol which satisfies a high security and achieves a high efficiency. Hereinafter, first an example of an existing bit commitment protocol and the problems of an existing bit commitment protocol will be described, and afterwards a bit commitment protocol according to an embodiment of the present disclosure will be described in detail.

### 2. Description of an Existing Bit Commitment Protocol

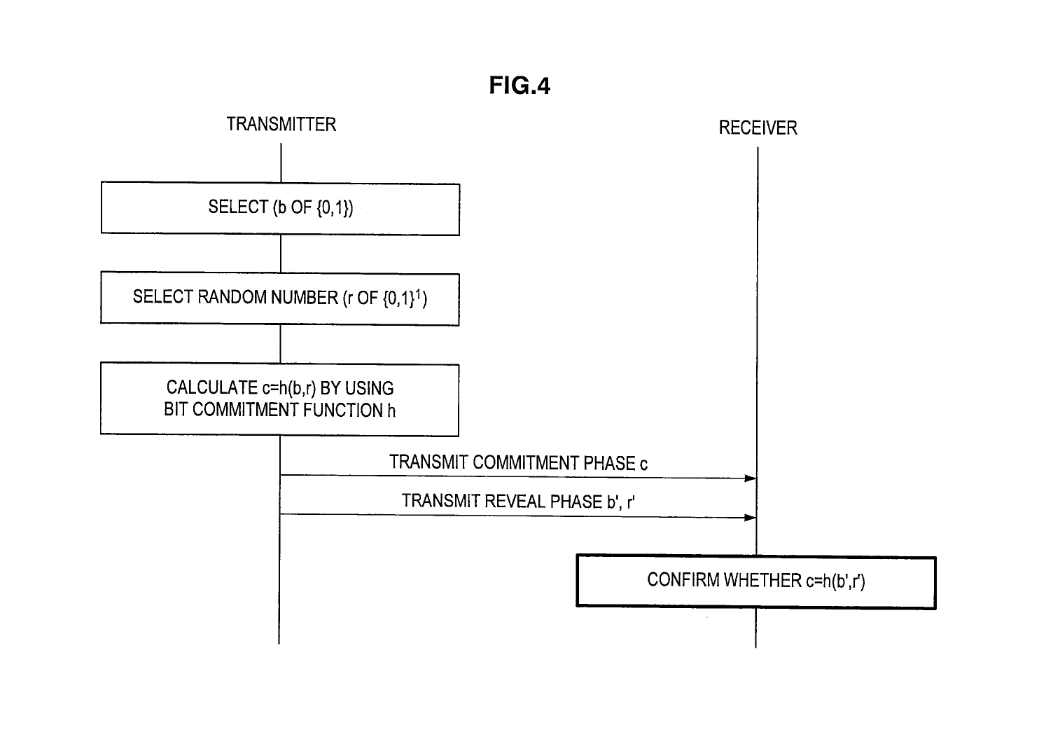

First, an existing bit commitment protocol will be described. FIG. 4 is a flow chart which shows the flow of a bit commitment protocol. Hereinafter, an existing bit commitment protocol will be described by using FIG. 4.

A bit commitment protocol, such as that shown in FIG. 4, is a protocol executed between a transmitter and a receiver. First, the transmitter selects a bit (b of {0,1}), and selects a random number (r of {0,1}¹). Then, the transmitter calculates c=h(b,r), by using a bit commitment function h. Note that in a bit commitment protocol, the function which generates a commitment c from the bit b and the random number r is called a bit commitment function.

When the commitment c is generated, the transmitter transmits the generated commitment c to the receiver. The stage at which this commitment c is transmitted from the transmitter to the receiver is called a commitment phase. The receiver does not know whether the bit b selected by the transmitter is 0 or 1, with only the commitment c sent from the transmitter.

Afterwards, the transmitter sends a bit b′ and a value r′ to the receiver, and the receiver confirms whether c=h(b′,r′), by using the bit commitment function h. Then, the receiver outputs the bit b′ sent from the transmitter, limited only to the case where c=h(b′,r′) holds. The stage at which this bit b′ and this value r′ are transmitted from the transmitter to the receiver is called a reveal phase. When the transmitter transmits values different from the bit b and random number r as a basis for the commitment c to the receiver in the reveal phase, the receiver can verify that values different from the bit b and the random number r as a basis for the commitment c have been sent in the reveal phase.

As described above, the purpose of bit commitment is to commit to a verifier the possession of bit data, without informing the values of this bit data possessed at present by the verifier himself or herself, and after this commitment, to be capable of verifying that this bit data has been committed at this time. Also, various applications can be implemented by using the bit commitment protocol.

For example, a bit commitment protocol can be used as a part of the constituent elements of another encryption system. For example, while a string commitment scheme is used as a part of the constituent elements by public key authentication schemes and digital signature schemes which take a basis for security from the difficulty in solving multi-order multivariate simultaneous equations, a bit commitment protocol can also be used as the constituent elements for implementing this string commitment scheme.

Additionally, a game of scissors-paper-rock can be implemented on a network by using a bit commitment protocol. Output after the game of scissors-paper-rock is strictly prohibited. However, since there is a condition in a game of scissors-paper-rock on a network in which the hands of mutual users are not able to be seen, and a delay or the like of the packets exists, verification of the output afterwards will be difficult. However, in a bit commitment protocol, while the transmitter sends his or her hand in advance, since this hand is not known to the receiver, or is not able to be changed afterwards, the hands of both the transmitter and the receiver can be determined securely without the other knowing his or her hand.

There are two types, hiding and binding, in the security obtained for a bit commitment protocol. Hiding is said to be when the bit b not able to be specified from the commitment c. There are two types, statistically hiding and computationally hiding, which exist in this hiding, and statistically hiding represents a higher security.

On the other hand, binding is said to be when bits different from the bit b sent in the commitment phase are not able to be output to the receiver. Specifically, it is said to have a characteristic in which (b′,r′) s.t.b′≠b of c=h(b,r)=h(b′,r′) is not able to be created. The bit commitment protocol should satisfy the two types of security of this hiding and this binding.

However, in a bit commitment protocol of the related art, there are cases where a high security is not satisfied, or the efficiency is reduced in order to satisfy a high security.

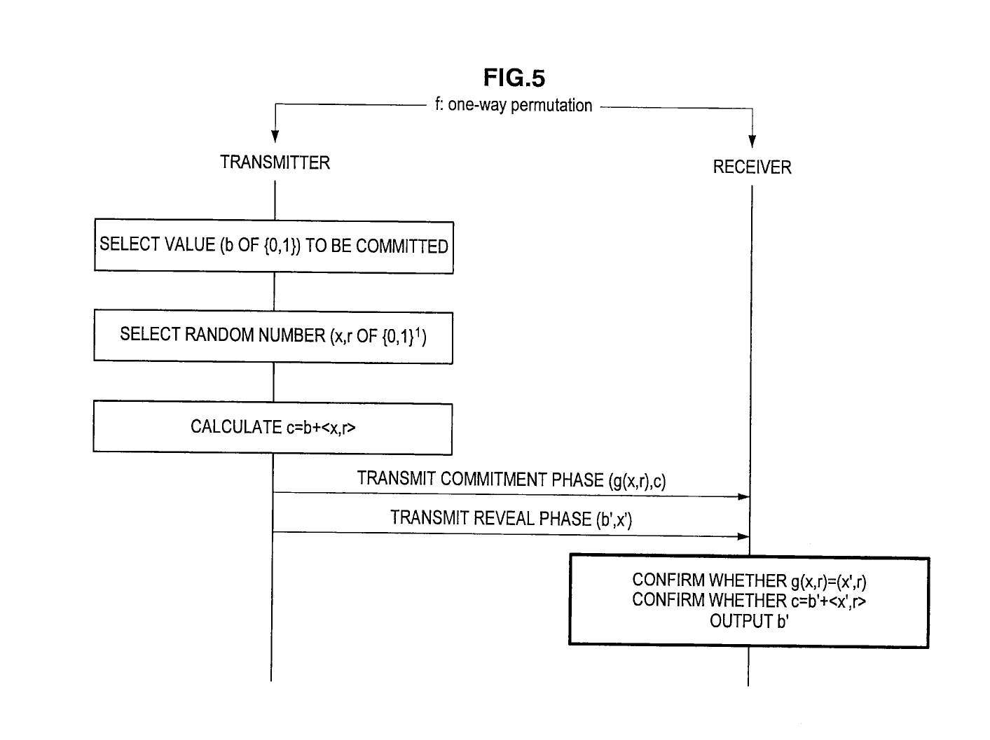

FIG. 5 is a flow chart which shows the flow of an existing bit commitment protocol. The flow chart shown in FIG. 5 is the flow of a bit commitment protocol configured based on a one-way function, and is disclosed in O. Goldreich and L. A. Levin, A Hard-Core Predicate for all One-Way Functions, STOC 1989; and Iftach Haitner, Minh-Huyen Nguyen, Shien Jin Ong, Omer Reingold, Salil Vadhan: Statistically Hiding Commitments and Statistical Zero-Knowledge Arguments from Any One-Way Function, SIAM Journal on Computing 2009. Hereinafter, an existing bit commitment protocol will be described by using FIG. 5.

First, in the flow shown in FIG. 5,

g(x,r):=f(x)∥r

is defined. Further, a function f is shared between the transmitter and the receiver. Similar to the flow shown in FIG. 4, the transmitter selects a bit (b of {0,1}), and selects a random number (r of {0,1}¹). Then, the transmitter calculates a commitment c=b+<x,r>. Note that <x,r> has the meaning of calculating the inner product of x and r, and “+” means an exclusive-OR operation.

When the commitment c is calculated, the transmitter transmits g(x,r) and the commitment c in the commitment phase to the receiver. Then, the transmitter transmits values b′ and x′ in the reveal phase. The receiver confirms whether g(x,r)=g(x′,r), and if g(x,r)=g(x′,r), to continue, the receiver confirms whether the commitment c is c=b′+<x′,r>. If c=b′+<x′,r>, the receiver outputs the value b′ transmitted in the reveal phase from the transmitter.

However, in the bit commitment protocol disclosed in O. Goldreich and L. A. Levin, A Hard-Core Predicate for all One-Way Functions, STOC 1989, only a minimum security (computationally hiding) is satisfied, and in addition a high security (statistically hiding) is not satisfied. Note that, computationally hiding is said to have a characteristic in which the committed values are not known to the receiver, who only has a calculation ability of some extent or below. Further, statistically hiding is said to have a characteristic in which the committed values are not known to the receiver who has some type of calculation ability.

Further, in the bit commitment protocol disclosed in Iftach Haitner, Minh-Huyen Nguyen, Shien Jin Ong, Omer Reingold, Salil Vadhan: Statistically Hiding Commitments and Statistical Zero-Knowledge Arguments from Any One-Way Function, SIAM Journal on Computing 2009, while statistically hiding can be achieved, a problem occurs in which it is said that the efficiency is reduced, by the necessary communication frequency increasing between the transmitter and the receiver in order to achieve statistically hiding.

Accordingly, in an embodiment of the present disclosure, a bit commitment protocol is shown which can achieve statistically hiding without reducing the efficiency, by using characteristics of the MQ function specifications such as those described above.

### 3. The Embodiments of the Present Disclosure

### System Configuration Example

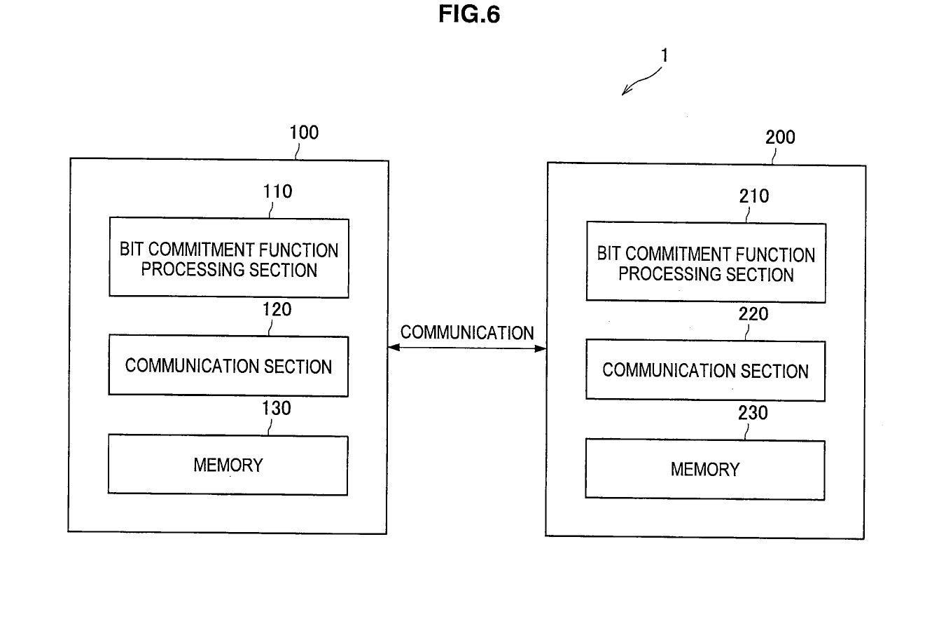

FIG. 6 is an explanatory view illustrating a configuration example of an information processing system 1 according to an embodiment of the present disclosure. Hereinafter, a configuration example of the information processing system 1 according to an embodiment of the present disclosure will be described by using FIG. 6.

As shown in FIG. 6, the information processing system 1 according to an embodiment of the present disclosure is constituted of information processing apparatuses 100 and 200. Here, the information processing apparatus 100 is an apparatus of the transmitter side in the bit commitment protocol, and the information processing apparatus 200 is an apparatus of the receiver side in the same bit commitment protocol.

The information processing apparatus 100 is constituted of a bit commitment function processing section 110, a communication section 120, and a memory 130. Further, the information processing apparatus 200 is constituted of a bit commitment function processing section 210, a communication section 220, and a memory 230.

First, a functional configuration of the information processing apparatus 100 will be described. The bit commitment function processing section 110 executes processes using a function used by the bit commitment protocol. While it will be specifically described later, the bit commitment function processing section 110 executes processes using an MQ function, by using characteristics of the MQ function in which it is possible to obtain x₁, x₂ which serve as F(x₁)=F(x₂).

The communication section 120 executes communication processes for the network, and in the present embodiment, executes communication with the information processing apparatus 200. The communication processes executed by the communication section 120 may be by wired or wireless communication. In the present embodiment, the communication section 120 transmits the contents processed by the bit commitment function processing section 110 to the information processing apparatus 200.

The memory 130 is a recording medium which stores information used for various processes in the information processing apparatus 100, and which is used as a temporary work memory at the time of performing the various processes.

Next, a functional configuration of the information processing apparatus 200 will be described. The bit commitment function processing section 210 executes processes using the functions used by the bit commitment protocol. While it will be specifically described later, the bit commitment function processing section 210 performs verification of the commitment generated by the information processing apparatus 100, by using an MQ function.

The communication section 220 executes communication processes for the network, and in the present embodiment, executes communication with the information processing apparatus 100. The communication processes executed by the communication section 220 may be by wired or wireless communication. In the present embodiment, the communication section 220 receives information transmitted from the information processing apparatus 100, when performing the execution of the bit commitment protocol, and supplies the received information to the bit commitment function processing section 210.

The memory 230 is a recording medium which stores information used for various processes in the information processing apparatus 200, and which is used as a temporary work memory at the time of performing the various processes.

The information processing system 1 according to an embodiment of the present disclosure executes a bit commitment protocol between the information processing apparatus 100 and the information processing apparatus 200. The bit commitment protocol executed by the information processing system 1 uses characteristics of the MQ function in which it is possible to obtain x₁, x₂ which serve as F(x₁)=F(x₂), and is implemented by using such a relation, by allocating {0,1} to x₁, x₂, and by transmitting the elements in each of the commitment phase and the reveal phase from the information processing apparatus 100 to the information processing apparatus 200.

Heretofore, a configuration example of the information processing system 1 according to an embodiment of the present disclosure has been described by using FIG. 6. Next, an operation example of the information processing system 1 according to an embodiment of the present disclosure will be described.

### System Operation Example

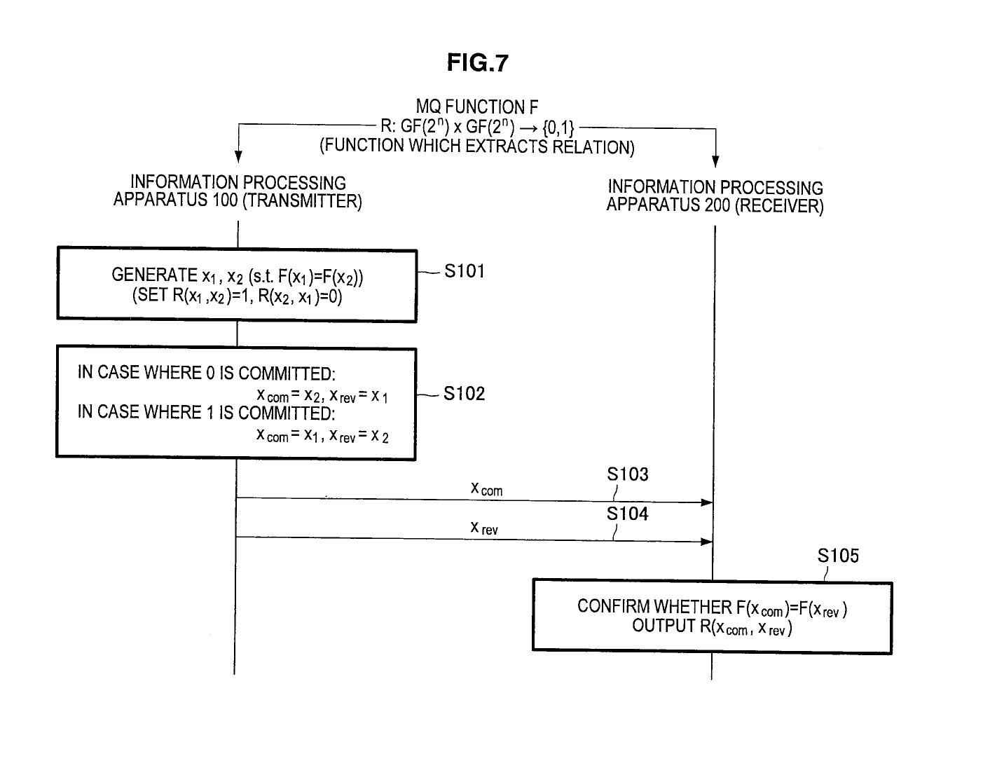

FIG. 7 is a flow chart which shows an operation example of the information processing system 1 according to an embodiment of the present disclosure. The flow chart shown in FIG. 7 is a bit commitment protocol executed between the information processing apparatus 100 and the information processing apparatus 200. Hereinafter, an operation example of the information processing system 1 according to an embodiment of the present disclosure will be described by using FIG. 7.

First, some relation R is shared between the information processing apparatus 100 and the information processing apparatus 200, before the execution of the bit commitment protocol. This relation R is defined as follows.

R:GF(2ⁿ)×GF(2ⁿ)→{0,1}

That is, the relation R is a relation in which the value of 1 bit can be determined from the values of two n bits.

The information processing apparatus 100 of the transmitter side generates x₁, x₂ which serve as F(x₁)=F(x₂) in the bit commitment function processing section 110, by using the MQ function F (step S101). For example, R(x₁, x₂) is a relation in which 0 is output if x₁<x₂, and 1 is output otherwise. Here, the relationship between the relation R and x₁, x₂ is R(x₁, x₂)=1 and R(x₂, x₁)=0.

To continue, the information processing apparatus 100 determines the values to be committed in the bit commitment function processing section 110 (step S102). In the present embodiment, in the case where the information processing apparatus 100 commits 0, information x_{com} transmitted in the commitment phase is x_{com}=x₂, and information xᵣₑᵥ transmitted in the reveal phase is xᵣₑᵥ=x₁. Further, in the case where the information processing apparatus 100 commits 1, the information x_{com} transmitted in the commitment phase is x_{com}=x₁, and the information xᵣₑᵥ transmitted in the reveal phase is xᵣₑᵥ=x₂.

To continue, the information processing apparatus 100 transmits the information x_{com} in the commitment phase to the information processing apparatus 200 (step S103), and to continue, transmits the information xᵣₑᵥ in the reveal phase to the information processing apparatus 200 (step S104).

When x_{com} and xᵣₑᵥ are received from the information processing apparatus 100, the information processing apparatus 200 confirms whether F(x_{com})=F(xᵣₑᵥ) (step S105). If F(x_{com})=F(xᵣₑᵥ), it is judged that the values committed by the information processing apparatus 100 have been correctly transmitted to the information processing apparatus 200, and the information processing apparatus 200 outputs R(x_{com}, xᵣₑᵥ). On the other hand, if F(x_{com})=F(xᵣₑᵥ) is not satisfied, it is judged that values which are not the values committed by the information processing apparatus 100 have been transmitted to the information processing apparatus 200, and the information processing apparatus 200 does not perform output of the values.

In this way, the information processing system 1 according to the present embodiment shares a prescribed function between the transmitter side and the receiver side in advance, and can ensure the security of the bit commitment protocol without reducing the efficiency, by using characteristics of the MQ function in which it is possible to obtain x₁, x₂ which serve as F(x₁)=F(x₂).

While a bit commitment protocol with an improved security can be implemented by using such an MQ function, the security of the bit commitment protocol can be further improved by setting the relation R to be more complex.

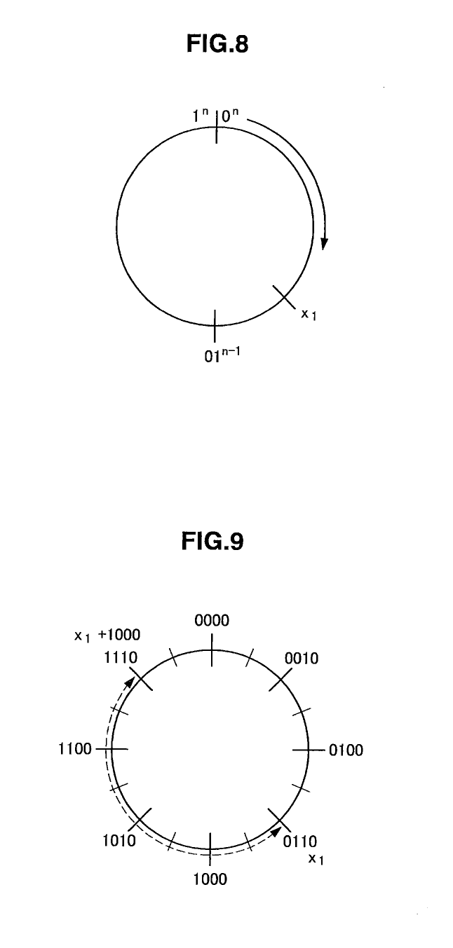

For example, as described above, when x₁ or x₂ of n bits has been clarified, it becomes possible for a relation R(x₁, x₂), in which 0 is output if x₁<x₂ or 1 is output otherwise, to be predicted with a random significance, for a magnitude relation between x₁ and x₂, by whether this value is close to 0ⁿ (0000 if 4 bits), or whether this value is close to 1ⁿ (1111 if 4 bits). FIG. 8 is an explanatory view illustrating the prediction of a magnitude relation between x₁ and x₂ by a value of x₁. As shown in FIG. 8, in the case where x₁ is between 0-2ⁿ⁻¹, a prediction can be made where the probability of x₁<x₂ appears to be high, and in the case where x₁ is between 2ⁿ⁻¹-2ⁿ, a prediction can be made where the probability of x₁>x₂ appears to be high. Needless to say, there is a problem from the viewpoint of probability, and while a relation such as that described above does not necessarily hold, it may be more desirable to provide a relation in which even such a prediction is not possible, in order to improve the security of the bit commitment protocol.

Accordingly, hereinafter, an example will be described with an improved security of the bit commitment protocol by providing a more complex relation R.

When x₁ is clarified, the above described relation R can be predicted to some extent by the value of R(x₁, x₂) regardless of the remaining values, by whether this value is near to or far from 0ⁿ which is a fixed value. Therefore, an example will be described of the case where a prediction is made difficult for determining the value of R(x₁, x₂) from whether this value is near to or far from a dependent value, even if x₁ has been clarified.

For example, the security of hiding in the bit commitment protocol can be improved, by providing a relation R2 (x₁, x₂) such as shown below.

```
if (x₁<10ⁿ⁻¹) {
    if (x₁<x₂<x₁<10ⁿ⁻¹) {
        output 1
    } else {
        output 0
    }
} else {
    if (x₁+10ⁿ⁻¹<x₂<x₁) {
        output 0
    } else {
        output 1
    }
}
```

That is, the relation R2 (x₁, x₂) is x₁<10ⁿ⁻¹ (1000 if n is 4) and additionally x₁<x₂ for x₁, x₂ of n bits, and is 1 if x₂<x₁+10ⁿ⁻¹ and 0 otherwise. Further, the relation R(x₁, x₂) is x₁≧10ⁿ⁻¹ and additionally x₁+10ⁿ⁻¹<x₂ for x₁, x₂ of n bits, and is 0 if x₂<x₁ and 1 otherwise.

FIG. 9 is an explanatory view visually illustrating this relation R2 (x₁, x₂). For example, in the case where x₁ is “0110” for x₁, x₂ of 4 bits, the relation R2 (x₁, x₂) is defined in which 1 is output if x₂ is at the location shown by the dotted line arrow, and 0 is output otherwise. That is, by using this relation R2 (x₁, x₂), and assuming that x₂ satisfying F(x₁)=F(x₂) for x₁ is distributed at random on {0,1}ⁿ, a prediction of R2 (x₁, x₂) when x₁ is some value becomes extremely difficult, and the security of hiding will be improved in the bit commitment protocol.

In this way, by configuring the bit commitment protocol by making use of the characteristics of an MQ function, the communication frequency between the transmitter and the receiver is performed one time in each of the commitment phase and the reveal phase, and an efficient bit commitment protocol can be implemented.

Further, at the time when n≧m for the parameters n, m of the MQ function, the number of expected values inverse to some value (y of {0,1}^{m}) will be 2^{n-m} or more. From this, by setting n large to some extent for m, the receiver will not be able to correctly predict the values sent in the reveal phase, and the security can be ensured. A setting such as n≧2m can be considered as the setting of the parameters for satisfying this security. For example, n and m may be set so that (n, m)=(160, 80) or (256, 128) in order to satisfy this security.

Further, by appropriately defining the relation (for example, by defining such as in the relation R2 described above), statistically hiding can be achieved.

### Modified Example

In this way, the information processing system 1 according to an embodiment of the present disclosure can ensure the security of a bit commitment protocol without reducing the efficiency, by using characteristics of an MQ function in which it is possible to obtain x₁, x₂ which serve as F(x₁)=F(x₂). The information processing system 1 according to an embodiment of the present disclosure may expand this bit commitment protocol to a string commitment protocol.

While in a bit commitment protocol, the transmitter transmits {0,1} to a partner, in a string commitment protocol, the transmitter transmits information of {0,1} or more (for example, {0,1,2}, or {0,1}^{z} of z bits) to a partner.

As described above, an MQ function can calculate x₁, x₂, . . . , x_{c+1} which serve as F(x₁)=F(x₂)= . . . =F(x_{c+1}) for m, n which is n=cm. It is possible to implement a string commitment protocol, by allocating {0,1}^{z} of z bits by using some relation, for this x₁, x₂, . . . , x_{c+1}, and to send each element in the commitment phase and the reveal phase.

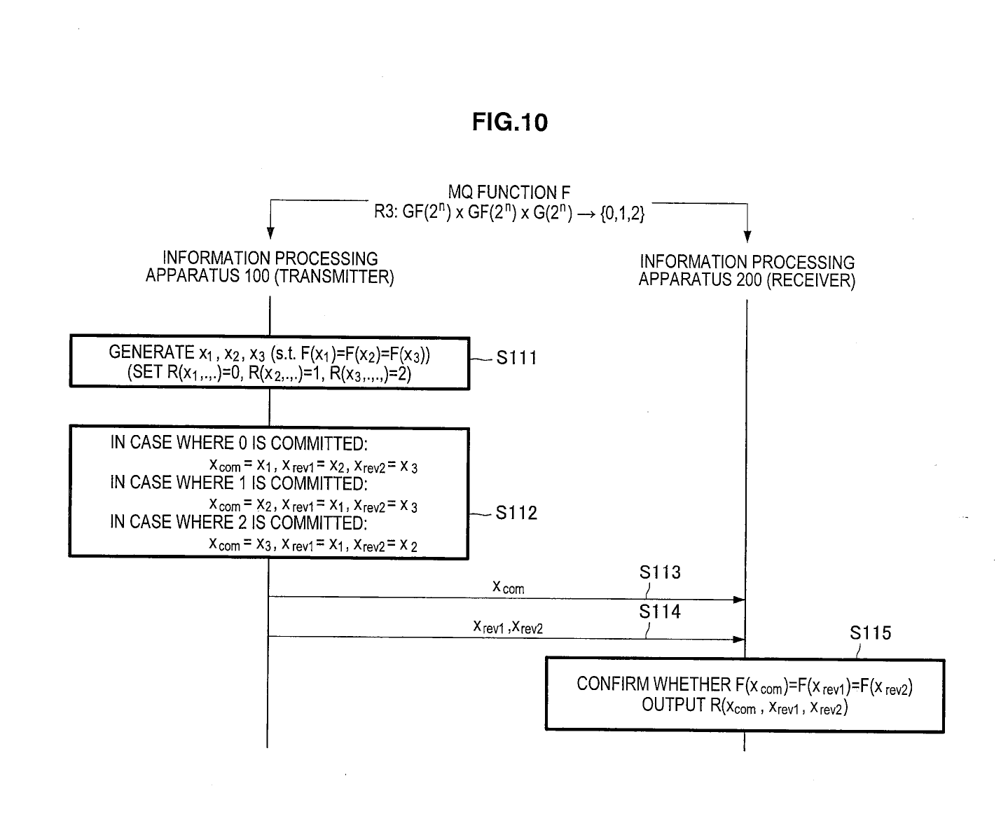

FIG. 10 is a flow chart which shows the flow of a string commitment protocol using the information processing system 1 according to an embodiment of the present disclosure. Hereinafter, a string commitment protocol using the information processing system 1 according to an embodiment of the present disclosure will be described by using FIG. 10.

First, some relation R3 is shared between the information processing apparatus 100 and the information processing apparatus 200, before the execution of the string commitment protocol. This relation R3 is defined as follows.

R3:GF(2ⁿ)×GF(2ⁿ)×GF(2ⁿ)→{0,1,2}

That is, the relation R3 is a relation in which any of the values of 0, 1, and 2 can be determined from the values of three n bits.

The information processing apparatus 100 of the transmitter side generates x₁, x₂, x₃ which serve as F(x₁)=F(x₂)=F(x₃) in the bit commitment function processing section 110, by using the MQ function F (step S111). Here, the relation between the relation R3 and x₁, x₂, x₃ is R3(x₁, . . . ,)−0, R3(x₂, . . . ,)=1, and R3(x₃, . . . ,)=2.

To continue, the information processing apparatus 100 determines the values to be committed in the bit commitment function processing section 110 (step S112). In this modified example, in the case where the information processing apparatus 100 commits 0, information x_{com} transmitted in the commitment phase is x_{com} x₁, and information xᵣₑᵥ transmitted in the reveal phase is xᵣₑᵥ₁=x₂ and xᵣₑᵥ₂=x₃. Further, in the case where the information processing apparatus 100 commits 1, the information x_{com} transmitted in the commitment phase is x_{com}=x₂, and the information xᵣₑᵥ transmitted in the reveal phase is xᵣₑᵥ₁=x₁ and xᵣₑᵥ₂=x₃. Further, in the case where the information processing apparatus 100 commits 2, the information x_{com} transmitted in the commitment phase is x_{com}=x₃, and the information xᵣₑᵥ transmitted in the reveal phase is xᵣₑᵥ₁=x₁ and xᵣₑᵥ₂=x₂.

To continue, the information processing apparatus 100 transmits the information x_{com}, in the commitment phase to the information processing apparatus 200 (step S113), and to continue, transmits the information xᵣₑᵥ₁ and xᵣₑᵥ₂ in the reveal phase to the information processing apparatus 200 (step S114).

When x_{com}, xᵣₑᵥ₁ and xᵣₑᵥ₂ are received from the information processing apparatus 100, the information processing apparatus 200 confirms whether F(x_{com})=F(xᵣₑᵥ₁)=F(xᵣₑᵥ₂) (step S115). If F(x_{com})=F(xᵣₑᵥ₁)=F(xᵣₑᵥ₂), it is judged that the values committed by the information processing apparatus 100 have been correctly transmitted to the information processing apparatus 200, and the information processing apparatus 200 outputs R3(x_{com}, xᵣₑᵥ₁, xᵣₑᵥ₂). On the other hand, if F(x_{com})=F(xᵣₑᵥ₁)=F(xᵣₑᵥ₂) is not satisfied, it is judged that values which are not the values committed by the information processing apparatus 100 have been transmitted to the information processing apparatus 200, and the information processing apparatus 200 does not perform output of the values.

In this way, the information processing system 1 according to the present embodiment shares a prescribed relation between the transmitter side and the receiver side in advance, and a string commitment protocol can be implemented by using characteristics of the MQ function in which it is possible to obtain x₁, x₂, x₃ which serve as F(x₁)=F(x₂)=F(x₃).

As described above, a bit commitment protocol executed by the information processing system 1 according to an embodiment of the present disclosure can achieve statistically hiding, by setting n≧2m for the parameters n, m of the MQ function. However, in the case where n≧2m, x₁, x₂, x₃ which serve as F(x₁)=F(x₂)=F(x₃) can be calculated.

For example, in the case where x₁, x₂, x₃ which serve as F(x₁)=F(x₂)=F(x₃) can be calculated, in the bit commitment protocol shown in FIG. 7, in the case where the information processing apparatus 100 transmits x₁ at the time of the commitment phase, the information processing apparatus 100 freely selects either of the two remaining x₂ and x₃ at the time of the reveal phase afterwards. In this case, there is the possibility that a difference in the output of the information processing apparatus 200 of the receiver side will appear between the case where x₂ is selected and the case where x₃ is selected.

Accordingly, a modified example for achieving binding in the case of n≧3m will be described. Here, in the case of n≧3m, it can be verified whether there are effective variables at the receiver side, by providing a restriction for a generation method of variables other than x₁, x₂.

Specifically, such a restriction is provided. In the case where n=cm, the transmitter sets Δ₂, Δ₃, . . . , Δ_{c} as (Δ₂, Δ₃, . . . , Δ_{c})=(d₃, d₄, . . . , d_{c+1}), by using the constants d₃, d₄, . . . , d_{c+1} provided within the protocol in advance, and generates x₁, . . . , x_{c+1} which serve as F(x₁)= . . . =F(x_{c+1}). Also, the transmitter transmits all of x₃, . . . , x_{c+1} other than x₁, x₂ at the time of the reveal phase, and the receiver verifies that x₃, . . . , x_{c+1} have the differences (d₃, . . . , d_{c+1}), respectively, for x₁ (or x₂). In this way, variables more than those necessary at the transmitter side are restricted so that x₃, . . . , x_{c+1} are not able to be used.

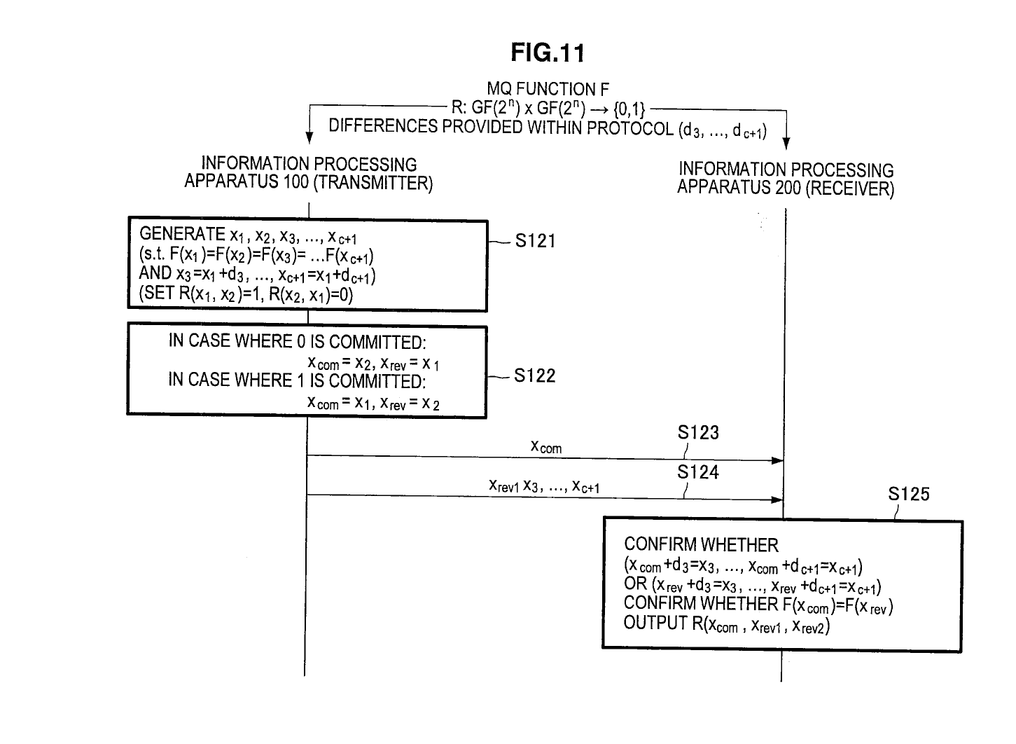

FIG. 11 is a flow chart which shows an operation example of the information processing system 1 according to an embodiment of the present disclosure. The flow chart shown in FIG. 11 is a bit commitment protocol executed between the information processing apparatus 100 and the information processing apparatus 200. A modified example of the bit commitment protocol shown in FIG. 7 is shown. Hereinafter, an operation example of the information processing system 1 according to an embodiment of the present disclosure will be described by using FIG. 1.

First, some relation R is shared between the information processing apparatus 100 and the information processing apparatus 200, before the execution of the bit commitment protocol. This relation R is defined as follows.

R:GF(2ⁿ)×GF(2ⁿ)→{0,1}

That is, the relation R is a relation in which the value of 1 bit can be determined from the values two n bits.

In addition, the above described differences (d₃, . . . , d_{c+1}) are shared between the information processing apparatus 100 and the information processing apparatus 200, before the execution of the bit commitment protocol.

The information processing apparatus 100 of the transmitter side generates x₁, . . . , x_{c+1} which serve as F(x)= . . . =F(x_{c+1}) and in which x₃=x₁+d₃, . . . , x_{c+1}=x₁+d_{c+1}, in the bit commitment function processing section 110, by using the MQ function F (step S121).

To continue, the information processing apparatus 100 determines the values to be committed in the bit commitment function processing section 110 (step S122). In this modified example, similar to that of the bit commitment protocol shown in FIG. 7, in the case where the information processing apparatus 100 commits 0, information x_{com} transmitted in the commitment phase is x_{com}=x₂, and information xᵣₑᵥ transmitted in the reveal phase is xᵣₑᵥ=x₁. Further, in the case where the information processing apparatus 100 commits 1, the information x_{com} transmitted in the commitment phase is x_{com}=x₁, and the information xᵣₑᵥ transmitted in the reveal phase is xᵣₑᵥ=x₂.

To continue, the information processing apparatus 100 transmits the information x_{com} in the commitment phase to the information processing apparatus 200 (step S123), and to continue, transmits the information xᵣₑᵥ in the reveal phase, and x₃, . . . , x_{c+1} which are the remaining values generated in the above described step S121, to the information processing apparatus 200 (step S124).

When x_{com}, xᵣₑᵥ and x₃, . . . , x_{c+1} are received from the information processing apparatus 100, the information processing apparatus 200 confirms whether x_{com}+d₃=x₃, . . . , x_{com}+d_{c+1}=x_{c+i}) and (xᵣₑᵥ+d₃=x₃, . . . , xᵣₑᵥ+d_{c+1}=x_{c+1}), by the bit commitment function processing section 210, and confirms whether F(x_{com})=F(xᵣₑᵥ) (step S125). If all the above described conditions are satisfied, it is judged that the values committed by the information processing apparatus 100 have been correctly transmitted to the information processing apparatus 200, and the information processing apparatus 200 outputs R(x_{com}, xᵣₑᵥ). On the other hand, if all the above described conditions are not satisfied, it is judged that values which are not the values committed by the information processing apparatus 100 have been transmitted to the information processing apparatus 200, and the information processing apparatus 200 does not perform output of the values.

In this way, by providing a restriction for the generation method of the variables other than x₁, x₂ generated by the information processing apparatus 100 of the transmitter side, it can be verified whether there are effective variables at the information processing apparatus 200 of the receiver side, and a bit commitment protocol can be implemented in which the security is high and the efficiency is good.

### 4: Hardware Configuration

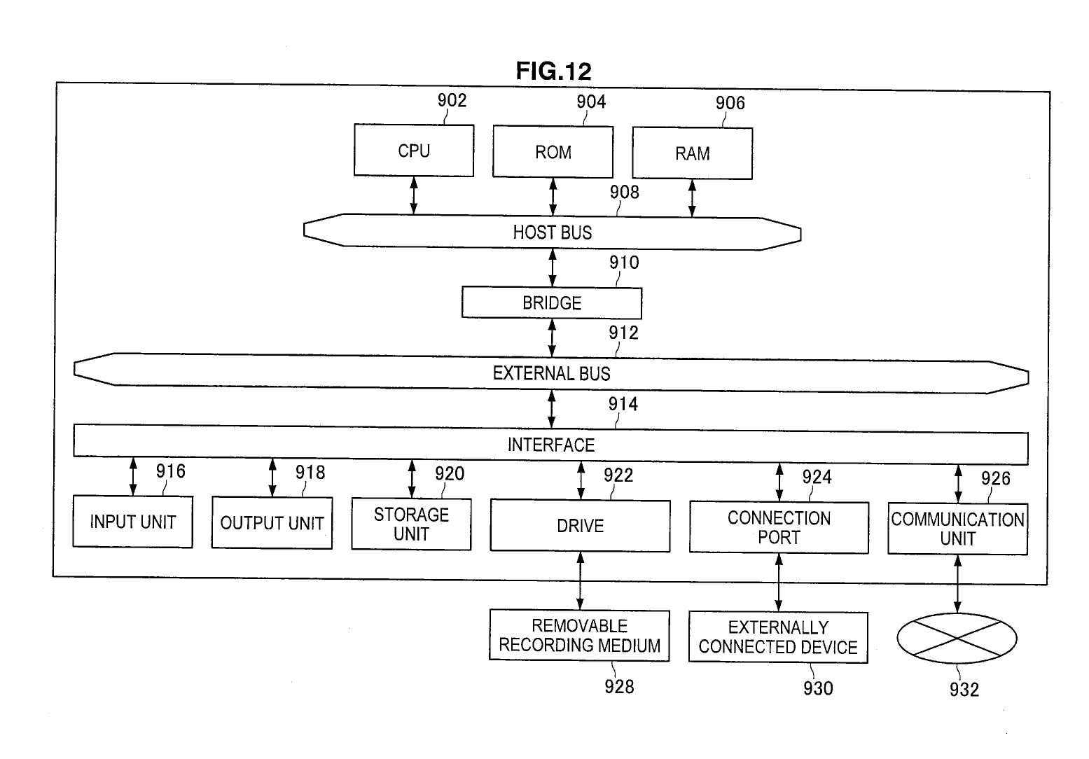

Each algorithm described above can be performed by using, for example, the hardware configuration of the information processing apparatus shown in FIG. 12. That is, processing of each algorithm can be realized by controlling the hardware shown in FIG. 12 using a computer program. Additionally, the mode of this hardware is arbitrary, and may be a personal computer, a mobile information terminal such as a mobile phone, a PHS or a PDA, a game machine, a contact or contactless IC chip, a contact or contactless IC card, or various types of information appliances. Moreover, the PHS is an abbreviation for Personal Handy-phone System. Also, the PDA is an abbreviation for Personal Digital Assistant.

As shown in FIG. 12, this hardware mainly includes a CPU 902, a ROM 904, a RAM 906, a host bus 908, and a bridge 910. Furthermore, this hardware includes an external bus 912, an interface 914, an input unit 916, an output unit 918, a storage unit 920, a drive 922, a connection port 924, and a communication unit 926. Moreover, the CPU is an abbreviation for Central Processing Unit. Also, the ROM is an abbreviation for Read Only Memory. Furthermore, the RAM is an abbreviation for Random Access Memory.

The CPU 902 functions as an arithmetic processing unit or a control unit, for example, and controls entire operation or a part of the operation of each structural element based on various programs recorded on the ROM 904, the RAM 906, the storage unit 920, or a removable recording medium 928. The ROM 904 is a means for storing, for example, a program to be loaded on the CPU 902 or data or the like used in an arithmetic operation. The RAM 906 temporarily or perpetually stores, for example, a program to be loaded on the CPU 902 or various parameters or the like arbitrarily changed in execution of the program.

These structural elements are connected to each other by, for example, the host bus 908 capable of performing high-speed data transmission. For its part, the host bus 908 is connected through the bridge 910 to the external bus 912 whose data transmission speed is relatively low, for example. Furthermore, the input unit 916 is, for example, a mouse, a keyboard, a touch panel, a button, a switch, or a lever. Also, the input unit 916 may be a remote control that can transmit a control signal by using an infrared ray or other radio waves.

The output unit 918 is, for example, a display device such as a CRT, an LCD, a PDP or an ELD, an audio output device such as a speaker or headphones, a printer, a mobile phone, or a facsimile, that can visually or auditorily notify a user of acquired information. Moreover, the CRT is an abbreviation for Cathode Ray Tube. The LCD is an abbreviation for Liquid Crystal Display. The PDP is an abbreviation for Plasma Display Panel. Also, the ELD is an abbreviation for Electro-Luminescence Display.

The storage unit 920 is a device for storing various data. The storage unit 920 is, for example, a magnetic storage device such as a hard disk drive (HDD), a semiconductor storage device, an optical storage device, or a magneto-optical storage device. The HDD is an abbreviation for Hard Disk Drive.

The drive 922 is a device that reads information recorded on the removable recording medium 928 such as a magnetic disk, an optical disk, a magneto-optical disk, or a semiconductor memory, or writes information in the removable recording medium 928. The removable recording medium 928 is, for example, a DVD medium, a Blu-ray medium, an HD-DVD medium, various types of semiconductor storage media, or the like. Of course, the removable recording medium 928 may be, for example, an electronic device or an IC card on which a non-contact IC chip is mounted. The IC is an abbreviation for Integrated Circuit.

The connection port 924 is a port such as an USB port, an IEEE1394 port, a SCSI, an RS-232C port, or a port for connecting an externally connected device 930 such as an optical audio terminal. The externally connected device 930 is, for example, a printer, a mobile music player, a digital camera, a digital video camera, or an IC recorder. Moreover, the USB is an abbreviation for Universal Serial Bus. Also, the SCSI is an abbreviation for Small Computer System Interface.

The communication unit 926 is a communication device to be connected to a network 932, and is, for example, a communication card for a wired or wireless LAN, Bluetooth (registered trademark), or WUSB, an optical communication router, an ADSL router, or a device for contact or non-contact communication. The network 932 connected to the communication unit 926 is configured from a wire-connected or wirelessly connected network, and is the Internet, a home-use LAN, infrared communication, visible light communication, broadcasting, or satellite communication, for example. Moreover, the LAN is an abbreviation for Local Area Network. Also, the WUSB is an abbreviation for Wireless USB. Furthermore, the ADSL is an abbreviation for Asymmetric Digital Subscriber Line.

### 5. Conclusion

According to the information processing system 1 according to an embodiment of the present disclosure such as described above, a prescribed relation is shared between the transmitter side and the receiver side in advance, and a bit commitment protocol can be executed using characteristics of an MQ function, in which it is possible to obtain x₁, x₂ which serve as F(x₁)=F(x₂). By executing the above described bit commitment protocol between the information processing apparatus 100 of the transmitter side and the information processing apparatus 200 of the receiver side, the information processing system 1 according to an embodiment of the present disclosure can ensure the security of the bit commitment protocol, without reducing the efficiency at the time of performing the execution of the bit commitment protocol.

Further, by setting the function shared in advance between the transmitter side and the receiver side to be complex, the information processing system 1 according to an embodiment of the present disclosure can improve the security of the bit commitment protocol. That is, by setting the relation shared in advance to be complex, a bit commitment protocol can be implemented in which the receiver is not able to estimate which values have been committed by the transmitter.

Note that in the above description, while an MQ function is included as the function F in which a same result is obtained from two or more different values, the present disclosure is not limited to such an example. Another function may be used, as an MQ function, if it is a function in which a same result is obtained from two or more different values.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1) An information processing apparatus including:

a function processing section which generates, in a state in which a function F which can calculate a same result for a plurality of different values x₁, . . . , xₙ (n is an integer of 2 or more), and a relation R between the values x₁, . . . , xₙ and values to be committed to another apparatus, are shared with the another apparatus in advance, the values x₁, . . . , xₙ which become a same result when applying the function F,

wherein the function processing section executes a commit stage which determines the values to be committed to the another apparatus by application of the relation R and a public stage which publically discloses the values committed in the commit stage, selects different values respectively corresponding to the values to be committed from the values x₁, . . . , xₙ in the commit stage and the public stage, and transmits the selected values to the another apparatus.

(2)
The information processing apparatus according to (1),

wherein the relation R is established, for values transmitted to the another apparatus in the commit stage, in a manner that the values to be committed to the another apparatus are not able to be predicted prior to the public stage.

(3)
The information processing apparatus according to (1),

wherein the relation R is established in a manner that values are determined by a magnitude relation of the values x₁, . . . , xₙ.

(4)
The information processing apparatus according to any one of (1) to (3),

wherein the value of n is 2.

(5)
The information processing apparatus according to any one of (1) to (3),

wherein the value of n is 3 or more, and

wherein the function processing section selects one value from the values x₁, . . . , xₙ in the commit stage by application of the relation R, transmits the selected value to the another apparatus, and transmits all other values in the public stage to the another apparatus.

(6)
The information processing apparatus according to any one of (1) to (3),

wherein the value of n is 3 or more, and

wherein the function processing section generates the values x₁, . . . , xₙ in accordance with a prescribed restriction, shares information of the prescribed restriction with the another apparatus, selects one value from the values x₁, . . . , xₙ in the commit stage by application of the relation R, transmits the selected value to the another apparatus, and transmits all other values in the public stage to the another apparatus.

(7)
The information processing apparatus according to any one of (1) to (6),
wherein the function F is a function of multivariate quadratic polynomial.
(8)
An information processing apparatus including:

a function processing section which applies, in a state in which a function F which can calculate a same result for a plurality of different values x₁, . . . , xₙ (n is an integer of 2 or more), and a relation R between the values x₁, . . . , xₙ and values to be committed by another apparatus, are shared with the another apparatus in advance, the function F to the values transmitted from the another apparatus,

wherein the function processing section executes a commit stage which receives first values corresponding to the values committed by the another apparatus by application of the relation R, and a public stage which receives second values for publically disclosing the values committed by the another apparatus, and

wherein the function processing section judges, in the public stage, whether or not the first values and the second values are different, and whether or not there is a same result when applying the function F to the first values and the second values.

(9)
The information processing apparatus according to (8),

wherein when there is a same result by applying the function F to the first values and the second values, the function processing section outputs a result applying the relation R to the first values and the second values.

(10)
The information processing apparatus according to (8),

wherein the value of n is 3 or more, and in a case where the values x₁, . . . , xₙ are generated by the another apparatus in accordance with a prescribed restriction, information of the prescribed restriction is shared with the another apparatus, and

wherein the function processing section judges, in the public stage, whether or not the values received from the another apparatus are generated under the prescribed restriction.

(11)
The information processing apparatus according to any one of (8) to (10),

wherein the function F is a function consisting of a b variable quadratic polynomial in a lines (a and b are each integers of 2 or more).

(12)
An information processing system including:

a first information processing apparatus and a second information processing apparatus,

wherein a function F which can calculate a same result for a plurality of different values x₁, . . . , xₙ (n is an integer of 2 or more), and a relation R between the values x₁, . . . , xₙ and values to be committed to the second apparatus, are shared between the first information processing apparatus and the second information processing apparatus,

wherein the first information processing apparatus includes a first function processing section which generates the values x₁, . . . , xₙ which become a same result when applying the function F,

wherein the first function processing section executes a commit stage which determines the values to be committed to the second information processing apparatus by application of the relation R and a public stage which publically discloses the values committed in the commit stage, selects different values respectively corresponding to the values to be committed from the values x₁, . . . , xₙ in the commit stage and the public stage, and transmits first values in the commit stage and second values in the public stage to the second information processing apparatus,

wherein the second information processing apparatus includes a second function processing section which applies the function F to the values transmitted from the first information processing apparatus,

wherein the second function processing section executes a commit stage which receives the first values corresponding to the values committed by the first information processing apparatus by application of the relation R, and a public stage which receives the second values for publically disclosing the values committed by the first information processing apparatus, and

wherein the function processing section judges, in the public stage, whether or not the first values and the second values are different, and whether or not there is a same result when applying the function F to the first values and the second values.

(13)
An information processing method including:

generating, in a state in which a function F which can calculate a same result for a plurality of different values x₁, . . . , xₙ (n is an integer of 2 or more), and a relation R between the values x₁, . . . , xₙ and values to be committed to another apparatus, are shared with the another apparatus in advance, the values x₁, . . . , xₙ which become a same result when applying the function F;

determining the values to be committed to the another apparatus by application of the relation R; and

publically disclosing the values committed by the commit step,

wherein different values respectively corresponding to the values to be committed from the values x₁, . . . , xₙ by the commit step and the publically disclosing step are selected, and the selected values are transmitted to the another apparatus.

(14)
An information processing method including:

receiving, in a state in which a function F which can calculate a same result for a plurality of different values x₁, . . . , xₙ (n is an integer of 2 or more), and a relation R between the values x₁, . . . , xₙ and values to be committed by another apparatus, are shared with the another apparatus in advance, first values corresponding to the values committed by the another apparatus by application of the relation R;

receiving second values for publically disclosing the values committed by the another apparatus; and

judging whether or not the first values and the second values are different, and whether or not there is a same result when applying the function F to the first values and the second values.

(15)
A computer program for causing a computer to execute:

generating, in a state in which a function F which can calculate a same result for a plurality of different values x₁, . . . , xₙ (n is an integer of 2 or more), and a relation R between the values x₁, . . . , xₙ and values to be committed to another apparatus, are shared with the another apparatus in advance, the values x₁, . . . , xₙ which become a same result when applying the function F;

determining the values to be committed to the another apparatus by application of the relation R; and

publically disclosing the values committed by the commit step,

wherein different values respectively corresponding to the values to be committed from the values x₁, . . . , xₙ by the commit step and the publically disclosing step are selected, and the selected values are transmitted to the another apparatus.

(16)
A computer program for causing a computer to execute:

receiving, in a state in which a function F which can calculate a same result for a plurality of different values x₁, . . . , xₙ (n is an integer of 2 or more), and a relation R between the values x₁, . . . , xₙ and values to be committed by another apparatus, are shared with the another apparatus in advance, first values corresponding to the values committed by the another apparatus by application of the relation R;

receiving second values for publically disclosing the values committed by the another apparatus; and

judging whether or not the first values and the second values are different, and whether or not there is a same result when applying the function F to the first values and the second values.

What is claimed is:

1. An information processing apparatus comprising:
circuitry configured to
generate, in a state in which a function F which can calculate a same result for a plurality of different values x₁, . . . , xₙ (n is an integer of 2 or more), and a relation R between the values x₁, . . . , xₙ and values to be committed to another apparatus, are shared with the another apparatus in advance, the values x₁, . . . , xₙ which become a same result when applying the function F,
execute a commit stage which determines the values to be committed to the another apparatus by application of the relation R and a public stage which publically discloses the values committed in the commit stage,
select different values respectively corresponding to the values to be committed from the values x₁, . . . , xₙ in the commit stage and the public stage, and
transmit the selected values to the another apparatus.

2. The information processing apparatus according to claim 1,
wherein the relation R is established, for values transmitted to the another apparatus in the commit stage, in a manner that the values to be committed to the another apparatus are not able to be predicted prior to the public stage.

3. The information processing apparatus according to claim 1,
wherein the relation R is established in a manner that values are determined by a magnitude relation of the values x₁, . . . , xₙ.

4. The information processing apparatus according to claim 1,
wherein the value of n is 2.

5. The information processing apparatus according to claim 1,
wherein the value of n is 3 or more, and
wherein the circuitry selects one value from the values x₁, . . . , xₙ in the commit stage by application of the relation R, transmits the selected value to the another apparatus, and transmits all other values in the public stage to the another apparatus.

6. The information processing apparatus according to claim 1,
wherein the value of n is 3 or more, and
wherein the circuitry generates the values x₁, . . . , xₙ in accordance with a prescribed restriction, shares information of the prescribed restriction with the another apparatus, selects one value from the values x₁, . . . , xₙ in the commit stage by application of the relation R, transmits the selected value to the another apparatus, and transmits all other values in the public stage to the another apparatus.

7. The information processing apparatus according to claim 1,
wherein the function F is a function of multivariate quadratic polynomial.

8. An information processing apparatus comprising:
circuitry configured to
apply, in a state in which a function F which can calculate a same result for a plurality of different values x₁, . . . , xₙ (n is an integer of 2 or more), and a relation R between the values x₁, . . . , xₙ and values to be committed by another apparatus, are shared with the another apparatus in advance, the function F to the values transmitted from the another apparatus,
execute a commit stage which receives first values corresponding to the values committed by the another apparatus by application of the relation R, and a public stage which receives second values for publically disclosing the values committed by the another apparatus, and
judge, in the public stage, whether or not the first values and the second values are different, and whether or not there is a same result when applying the function F to the first values and the second values.

9. The information processing apparatus according to claim 8,
wherein when there is a same result by applying the function F to the first values and the second values, the circuitry outputs a result applying the relation R to the first values and the second values.

10. The information processing apparatus according to claim 8,
wherein the value of n is 3 or more, and in a case where the values x₁, . . . , xₙ are generated by the another apparatus in accordance with a prescribed restriction, information of the prescribed restriction is shared with the another apparatus, and
wherein the circuitry judges, in the public stage, whether or not the values received from the another apparatus are generated under the prescribed restriction.

11. The information processing apparatus according to claim 8,
wherein the function F is a function consisting of a b variable quadratic polynomial in a lines (a and b are each integers of 2 or more).

12. An information processing system comprising:
a first information processing apparatus and a second information processing apparatus,
wherein a function F which can calculate a same result for a plurality of different values x₁, . . . , xₙ (n is an integer of 2 or more), and a relation R between the values x₁, . . . , xₙ and values to be committed to the second apparatus, are shared between the first information processing apparatus and the second information processing apparatus,
wherein the first information processing apparatus includes first circuitry which generates the values x₁, . . . , xₙ which become a same result when applying the function F,
wherein the first circuitry executes a commit stage which determines the values to be committed to the second information processing apparatus by application of the relation R and a public stage which publically discloses the values committed in the commit stage, selects different values respectively corresponding to the values to be committed from the values x₁, . . . , xₙ in the commit stage and the public stage, and transmits first values in the commit stage and second values in the public stage to the second information processing apparatus,
wherein the second information processing apparatus includes second circuitry which applies the function F to the values transmitted from the first information processing apparatus,
wherein the second circuitry executes a commit stage which receives the first values corresponding to the values committed by the first information processing apparatus by application of the relation R, and a public stage which receives the second values for publically disclosing the values committed by the first information processing apparatus, and
wherein the second circuitry judges, in the public stage, whether or not the first values and the second values are different, and whether or not there is a same result when applying the function F to the first values and the second values.

13. An information processing method comprising:
generating, in a state in which a function F which can calculate a same result for a plurality of different values x₁, . . . , xₙ (n is an integer of 2 or more), and a relation R between the values x₁, . . . , xₙ and values to be committed to another apparatus, are shared with the another apparatus in advance, the values x₁, . . . , xₙ which become a same result when applying the function F;
determining the values to be committed to the another apparatus by application of the relation R; and
publically disclosing the values committed by the commit step,
wherein different values respectively corresponding to the values to be committed from the values x₁, . . . , xₙ by the commit step and the publically disclosing step are selected, and the selected values are transmitted to the another apparatus.

14. An information processing method comprising:
receiving, in a state in which a function F which can calculate a same result for a plurality of different values x₁, . . . , xₙ (n is an integer of 2 or more), and a relation R between the values x₁, . . . , xₙ and values to be committed by another apparatus, are shared with the another apparatus in advance, first values corresponding to the values committed by the another apparatus by application of the relation R;
receiving second values for publically disclosing the values committed by the another apparatus; and
judging whether or not the first values and the second values are different, and whether or not there is a same result when applying the function F to the first values and the second values.

15. A computer program for causing a computer to execute:
generating, in a state in which a function F which can calculate a same result for a plurality of different values x₁, . . . , xₙ (n is an integer of 2 or more), and a relation R between the values x₁, . . . , xₙ and values to be committed to another apparatus, are shared with the another apparatus in advance, the values x₁, . . . , xₙ which become a same result when applying the function F;
determining the values to be committed to the another apparatus by application of the relation R; and
publically disclosing the values committed by the commit step,
wherein different values respectively corresponding to the values to be committed from the values x₁, . . . , xₙ by the commit step and the publically disclosing step are selected, and the selected values are transmitted to the another apparatus.

16. A computer program for causing a computer to execute:
receiving, in a state in which a function F which can calculate a same result for a plurality of different values x₁, . . . , xₙ (n is an integer of 2 or more), and a relation R between the values x₁, . . . , xₙ and values to be committed by another apparatus, are shared with the another apparatus in advance, first values corresponding to the values committed by the another apparatus by application of the relation R;
receiving second values for publically disclosing the values committed by the another apparatus; and
judging whether or not the first values and the second values are different, and whether or not there is a same result when applying the function F to the first values and the second values.
